(19) United States
(12) Patent Application Publication
(10) Pub. No.: US 2022/0250302 A1
(43) Pub. Date: Aug. 11, 2022

(54) Dispensing Systems And Methods Including Online Remixing Of Thermal Management And/Or EMI Mitigation Materials

(71) Applicant: Tianjin Laird Technologies Limited, Tianjin (CN)

(72) Inventors: Jingqi ZHAO, Tianjin (CN); Xuefeng LIN, Tianjin (CN)

(21) Appl. No.: 17/726,959

(22) Filed: Apr. 22, 2022

Related U.S. Application Data
(63) Continuation of application No. PCT/IB2020/000916, filed on Oct. 23, 2020.

(30) Foreign Application Priority Data
Oct. 24, 2019 (CN) 201911016058.4
Oct. 24, 2019 (CN) 201921795738.6

(51) Int. Cl. B29C 48/395; B29C 48/365; B29C 48/57; B29C 48/285

(52) U.S. Cl. CPC B29C 48/397; B29C 48/365; B29K 2105/16; B29C 48/2886; B29C 48/57

(57) ABSTRACT

Exemplary embodiments are disclosed of systems and methods for dispensing thermal management and/or EMI mitigation materials. The system and methods include online remixing prior to dispensing the thermal management and/or EMI mitigation materials. In an exemplary embodiment, a system includes an online remixer configured to be operable for receiving a supply of the thermal management and/or EMI mitigation material including one or more functional fillers within the matrix, and remixing the one or more functional fillers including filler settlement, if any, within the matrix prior to dispensement of the thermal management and/or EMI mitigation. The remixing may reduce the filler settlement, if any, within the matrix and thereby allow for improved viscosity and flow rate of the thermal management and/or EMI mitigation material.

### CROSS-REFERENCE TO RELATED APPLICATIONS

This application is a continuation of PCT Application No. PCT/IB2020/000916 filed Oct. 23, 2020 (which published as WO2021/079194 on Apr. 29, 2021). PCT Application No. PCT/IB2020/000916 claims priority to and the benefit of Chinese invention patent application No. 201911016058.4 filed Oct. 24, 2019 (published as CN112706311 on Apr. 27, 2021), and Chinese utility model application No. 201921795738.6 filed Oct. 24, 2019 (granted as ZL 201921795738.6 on Feb. 26, 2021). The entire disclosures of the above applications are incorporated herein by reference.

### FIELD

The present disclosure generally relates to systems and methods for dispensing thermal management and/or EMI mitigation materials. The system and methods include online remixing prior to dispensing the thermal management and/or EMI mitigation materials.

### BACKGROUND

This section provides background information related to the present disclosure which is not necessarily prior art.

Electrical components, such as semiconductors, integrated circuit packages, transistors, etc., typically have pre-designed temperatures at which the electrical components optimally operate. Ideally, the pre-designed temperatures approximate the temperature of the surrounding air. But the operation of electrical components generates heat. If the heat is not removed, the electrical components may then operate at temperatures significantly higher than their normal or desirable operating temperature. Such excessive temperatures may adversely affect the operating characteristics of the electrical components and the operation of the associated device.

To avoid or at least reduce the adverse operating characteristics from the heat generation, the heat should be removed, for example, by conducting the heat from the operating electrical component to a heat sink. The heat sink may then be cooled by conventional convection and/or radiation techniques. During conduction, the heat may pass from the operating electrical component to the heat sink either by direct surface contact between the electrical component and heat sink and/or by contact of the electrical component and heat sink surfaces through an intermediate medium or thermal interface material (TIM). The thermal interface material may be used to fill the gap between thermal transfer surfaces, in order to increase thermal transfer efficiency as compared to having the gap filled with air, which is a relatively poor thermal conductor.

In addition, a common problem in the operation of electronic devices is the generation of electromagnetic radiation within the electronic circuitry of the equipment. Such radiation may result in electromagnetic interference (EMI) or radio frequency interference (RFI), which can interfere with the operation of other electronic devices within a certain proximity. Without adequate shielding, EMI/RFI interference may cause degradation or complete loss of important signals, thereby rendering the electronic equipment inefficient or inoperable.

A common solution to ameliorate the effects of EMI/RFI is through the use of shields capable of absorbing and/or reflecting and/or redirecting EMI energy. These shields are typically employed to localize EMI/RFI within its source, and to insulate other devices proximal to the EMI/RFI source

The term “EMI” as used herein should be considered to generally include and refer to EMI emissions and RFI emissions, and the term “electromagnetic” should be considered to generally include and refer to electromagnetic and radio frequency from external sources and internal sources. Accordingly, the term shielding (as used herein) broadly includes and refers to mitigating (or limiting) EMI and/or RFI, such as by absorbing, reflecting, blocking, and/or redirecting the energy or some combination thereof so that it no longer interferes, for example, for government compliance and/or for internal functionality of the electronic component system.

### SUMMARY

This section provides a general summary of the disclosure and is not a comprehensive disclosure of its full scope or all of its features.

Exemplary embodiments are disclosed of systems and methods for dispensing thermal management and/or EMI mitigation materials. The system and methods include online remixing prior to dispensing the thermal management and/or EMI mitigation materials.

In an exemplary embodiment, a system includes an online remixer configured to be operable for receiving a supply of the thermal management and/or EMI mitigation material including one or more functional fillers within the matrix, and remixing the one or more functional fillers including filler settlement, if any, within the matrix prior to dispensement of the thermal management and/or EMI mitigation. The remixing may reduce the filler settlement, if any, within the matrix and thereby allow for improved viscosity and flow rate of the thermal management and/or EMI mitigation material.

Further areas of applicability will become apparent from the description provided herein. The description and specific examples in this summary are intended for purposes of illustration only and are not intended to limit the scope of the present disclosure.

### DRAWING

The drawing described herein is for illustrative purposes only of selected embodiments and not all possible implementations and is not intended to limit the scope of the present disclosure.

FIG. 1 illustrates a system for dispensing thermal management and/or EMI mitigation materials according to an exemplary embodiment in which the system includes online remixing equipment.

### DETAILED DESCRIPTION

Example embodiments will now be described more fully with reference to the accompanying drawing.

Composite materials including fillers within a matrix may be used in various applications, such as dispensable thermal interface materials (TIN/Is) and form-in-place (FIP) products. But as recognized herein, settlement of the filler within the matrix can pose challenges and impede the composite material from having a long term shelf life. The filler may settle within the matrix if the composite material is not dispensed until after a relatively long time. For example, the filler may settle within the matrix during storage and/or transport of the composite material.

Filler settlement may cause oil/filler separations and flow rate/viscosity changes over time (e.g., after storage, etc.), which, in turn, may lead to bad dispensing performance on the composite materials. The occurrence of the flow rate/viscosity changes over time may hinder and significantly limit the usage of composite materials. The viscosity/flow rate changes are mainly due to physical settlement of the heavier fillers in the lighter polymer matrix.

Conventional dispensing equipment adjust dispensing pressure to address the viscosity/flow rate changes caused by filler settlement. But with such conventional dispensing equipment, the dispensing pressure needs to be adjusted frequently. And if the oil/filler separation is significantly excessive or extreme, then the filler loading may vary greatly within the dispensed material. The varying differential filler loading or filler density within the dispensed material may negatively impact the functional properties (e.g., thermally-conductive, electrically-conductive, dielectric absorbing, electromagnetic wave absorbing, etc.) of the dispensed material.

After recognizing the above, exemplary embodiments were developed and/or disclosed herein of systems and methods that include remixing (e.g., homogeneously, etc.) of the filler(s), including filler settlement, within the matrix. After the remixing (e.g., via a screw extruder, screw kneader, other online remixer, etc.) of the filler(s) within the matrix, the viscosity/flow rate of the material may thereby be improved and/or returned back to its initial viscosity/flow rate. For example, the viscosity/flow rate of the material after the remixing may be substantially the same as the initial viscosity/flow rate of the material when the filler was initially mixed within the matrix to make the material and before occurrence of any filler settlement during a long term shelf life. Advantageously, the remixing may thus allow dispensable materials to have longer shelf lives before dispensement.

The exemplary embodiments of the systems and methods disclosed herein may be used with various thermal management and/or EMI mitigation materials, such as one-part dispensable materials (e.g., one-part thermal putties, etc.), two-part dispensable material (e.g., two-part cure in place dispensable thermal interface materials (TIMs), etc.), dispensable TIMs, dispensable EMI shielding materials, dispensable EMI absorbing materials, dispensable thermally-conductive EMI absorbers or hybrid thermal/EMI absorbers, dispensable materials having a high filler loading and/or high viscosity/flow rate, other dispensable materials, etc. Accordingly, aspects of the present disclosure should not be limited to remixing any single type of dispensable material.

In exemplary embodiments, a system/method includes remixing a dispensable material via an online remixer (e.g., screw extruder, screw kneader, other remixing equipment, etc.) before dispensing the dispensable material. The dispensable material may have a high filler loading and high viscosity/flow rate. The dispensable material may comprise a one-part or two-part dispensable thermal management and/or EMI mitigation material, such as a one-part thermal putty, a two-part cure in place dispensable TIM, etc. The remixing of the dispensable material is upstream of the material dispenser and occurs before the dispensable material is fed, transferred, or supplied (e.g., pumped via a high pressure pump, etc.) to the material dispenser. The remixing of the dispensable material may improve or maintain the viscosity/flow rate of the dispensable material. For example, the viscosity/flow rate of the dispensable material may change (e.g., worsen, etc.) over time due to filler settlement within the matrix of the dispensable material. In which case, the remixing of the dispensable material may alter (e.g., improve, return, etc.) the viscosity/flow rate of the dispensable material to be substantially the same as the initial viscosity/flow rate of the dispensable material before filler settlement occurred. Or, for example, the remixing of the dispensable material may maintain the viscosity/flow rate of the dispensable material by preventing or avoiding filler settlement.

In some exemplary embodiments, the dispensable material comprises one-part dispensable material (e.g., one-part thermal putty, etc.). In such exemplary embodiments, the system/method include remixing the one-part dispensable material via an online remixer (e.g., screw extruder, screw kneader, other remixing equipment, etc.) before dispensing the one-part dispensable material. Accordingly, the remixing of one-part dispensable material is upstream of the dispenser and occurs before the one-part dispensable material is fed, transferred, or supplied (e.g., pumped via a high pressure pump, etc.) to the material dispenser or dispensing machine. The remixing of the one-part dispensable material may improve or maintain the viscosity/flow rate of the one-part dispensable material. For example, the viscosity/flow rate of the one-part dispensable material may change (e.g., worsen, etc.) over time due to filler settlement within the matrix. In which case, the remixing of the one-part dispensable material may alter (e.g., improve, return, etc.) the viscosity/flow rate of the one-part dispensable material to be substantially the same as the initial viscosity/flow rate of the one-part dispensable material before filler settlement occurred. Or, for example, the remixing of the one-part dispensable material may maintain the viscosity/flow rate of the one-part dispensable material by preventing or avoiding filler settlement.

In other exemplary embodiments, the dispensable material comprises a two-part dispensable material (e.g., a two-part cure in place dispensable TIM, etc.). In such exemplary embodiments, the system/method includes remixing the two-part dispensable material via an online remixer (e.g., screw extruder, screw kneader, other remixing equipment, etc.) before dispensing the two-part dispensable material. The remixing of two-part dispensable material is upstream of a static mixer and a material dispenser. Accordingly, the remixing occurs before the two-part dispensable material is fed, transferred, or supplied (e.g., pumped via a high pressure pump, etc.) to the static mixer and the material dispenser. The remixing of the two-part dispensable material may improve or maintain the viscosity/flow rate of the two-part dispensable material. For example, the viscosity/flow rate of the two-part dispensable material may change (e.g., worsen, etc.) over time due to filler settlement within the matrix. In which case, the remixing of the two-part dispensable material may alter (e.g., improve, return, etc.) the viscosity/flow rate of the two-part dispensable material to be substantially the same as the initial viscosity/flow rate of the two-part dispensable material before filler settlement occurred. Or, for example, the remixing of the two-part dispensable material may maintain the viscosity/flow rate of the two-part dispensable material by preventing or avoiding filler settlement.

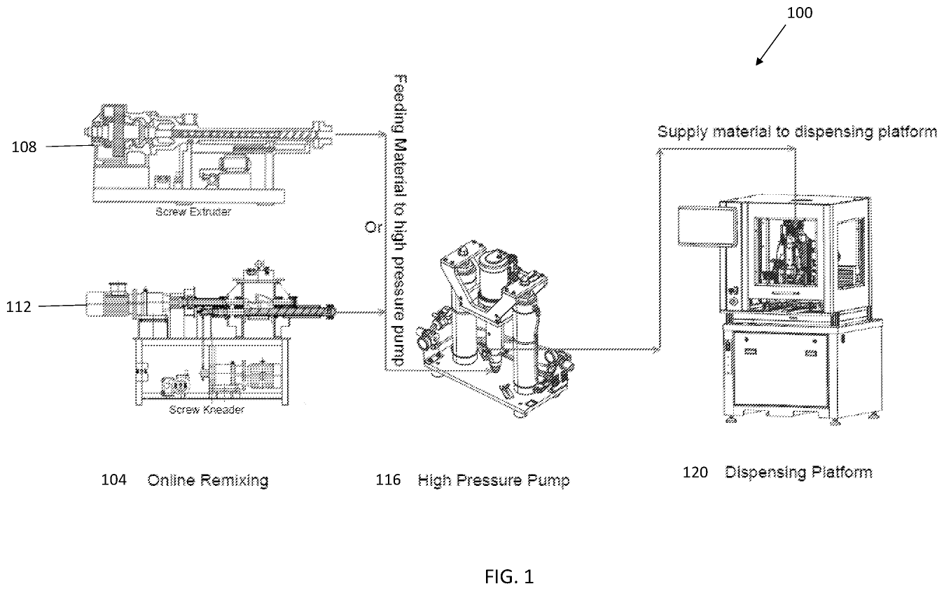

FIG. 1 illustrates a system 100 for dispensing thermal management and/or EMI mitigation materials according to an exemplary embodiment embodying one or more aspects of the present disclosure. As shown, the system 100 includes online remixing equipment 104 (broadly, a remixer). The online remixing equipment 104 may comprise a screw extruder 108, a screw kneader 112, etc.

The online remixing equipment 104 may be configured for receiving a supply of the thermal management and/or EMI mitigation material including the one or more functional fillers within the matrix. The online remixing equipment 104 may also be configured for remixing the one or more functional fillers including filler settlement, if any, within the matrix prior to dispensement of the thermal management and/or EMI mitigation. The remixing may reduce (e.g., eliminate, etc.) the filler settlement, if any, within the matrix and thereby allow for improved viscosity and flow rate of the thermal management and/or EMI mitigation material.

The system 100 also includes a pump 116 (e.g., a high pressure pump, etc.) and dispensing machine or platform 120 (broadly, a dispenser). The online remixing equipment 104 is upstream of the pump 116, such that the remixed material from the online remixing equipment 104 is fed to the pump 116. The pump 116 is configured to be operable for pumping or supplying the remixed material to the dispensing machine or platform 120.

The dispensing machine or platform 120 is configured to dispense (e.g., via a nozzle, etc.) the remixed material onto a surface, e.g., a board level shield, a printed circuit board, an electronic component, a heat source, a heat removal/dissipation structure or component (e.g., a heat spreader, a heat sink, a heat pipe, a device exterior case or housing, etc.), etc. For example, the dispenser 120 may dispense the remixed thermal management and/or EMI mitigation material relative to, against, and/or adjacent one or more heat sources and one or more heat removal/dissipation structures such that the dispensed thermal management and/or EMI mitigation material is operable for defining or establishing at least part of a thermally-conductive heat path generally between the one or more heat sources and the one or more heat removal/dissipation structures along which heat is transferrable. Or, for example, the dispenser 120 may dispense the remixed thermal management and/or EMI mitigation material relative to, against, and/or adjacent one or more device components such that the dispensed thermal management and/or EMI mitigation material is operable for providing EMI mitigation for the one or more device components.

In exemplary embodiments, the systems and methods are configured for remixing and dispensing of thermal management and/or EMI mitigation materials that include a matrix (e.g., a polymer matrix, etc.) and one or more functional fillers within the matrix. The one or more functional fillers may comprise thermally-conductive, electrically-conductive, dielectric absorbing, and/or electromagnetic wave absorbing filler, etc.

The one or more functional fillers may include thermally-conductive particles, electrically-conductive particles, dielectric absorbing particles, electromagnetic wave absorbing particles, and/or particles that are two or more of thermally-conductive, electrically-conductive, and electromagnetic wave absorbing. For example, the one or more functional fillers may include thermally-conductive particles including one or more of zinc oxide, boron nitride, alumina, aluminum, silicon nitride, aluminum nitride, iron, metallic oxides, graphite, silver, copper, ceramic, and/or combinations thereof. The one or more functional fillers may include a filler made of iron, ferrite, etc. The filler may be dielectrically absorbent (e.g., carbon black, silicon carbide, etc.). The one or more functional fillers may include EMI absorbing particles including one or more of silicon carbide, carbonyl iron, alumina, manganese zinc ferrite, magnetic flakes, an alloy containing about 85% iron, 9.5% silicon and 5.5% aluminum, an alloy containing about 20% iron and 80% nickel, iron silicide, iron-chrome compounds, metallic silver, magnetic alloys, magnetic powders, magnetic particles, nickel-based alloys and powders, chrome alloys, MagniF (iron oxide magnetite), and/or combinations thereof. The one or more functional fillers may include different grades of the same functional filler particles or different grades of different types of functional filler particles.

In some exemplary embodiments, the thermal management and/or EMI mitigation material may be usable for both thermal management purposes and EMI attenuation. For example, the thermal management and/or EMI mitigation material may comprise a thermally-conductive microwave absorber including functional filler that comprises silicon carbide, carbonyl iron powder, and alumina. Or, the thermal management and/or EMI mitigation material may comprise a thermally-conductive microwave absorber including functional filler that comprises silicon carbide, carbonyl iron powder, alumina, manganese zinc ferrite, and magnetic flake. Or, the functional filler may comprise alumina, silicon carbide, carbon black, MagniF (iron oxide magnetite), etc.

In some exemplary embodiments, the functional filler may comprise a significant majority of the total volume of the thermal management and/or EMI mitigation material. For example, the matrix may be loaded with the functional filler such that the volume percent (vol %) of the functional filler is within a range from about 85 vol % to about 98 vol % (e.g., about 90 vol %, about 98 vol %, greater than 85 vol %, etc.) and/or such that the weight percent of the functional filler is at least about 90 wt % or more. The volume percentages and weight percentages provided in this paragraph are exemplary only as other exemplary embodiments may include high or lower volume percentages and/or weight percentages of the functional filler.

The functional filler may vary in size, e.g., from about 0.01 mm and about 1.0 mm particle size (e.g., between 0.05 and 0.5 mm, between 0.07 and 0.15 mm, etc.). The shape(s) of the functional filler may also vary, e.g., round, spherical, flakes, rods, etc.

In some exemplary embodiments, the system may dispense the thermal management and/or EMI mitigation material to define a portion of thermally-conductive heat path along which heat is transferrable, e.g., from a heat source to a heat removal/dissipation structure or component (e.g., a heat spreader, a heat sink, a heat pipe, a device exterior case or housing, etc.). Generally, a heat source may include any component or device (e.g., integrated circuit, other PCB component, etc.) that has a higher temperature than the one-part curable dispensable thermal management and/or EMI mitigation material or otherwise provides or transfers heat to the one-part curable dispensable thermal management and/or EMI mitigation material regardless of whether the heat is generated by the heat source or merely transferred through or via the heat source. Accordingly, aspects of the present disclosure should not be limited to any particular use with any single type of heat source, electronic device, heat removal/dissipation structure, etc.

Accordingly, exemplary embodiments are disclosed of systems and methods for dispensing thermal management and/or EMI mitigation materials. The system and methods include online remixing prior to dispensing the thermal management and/or EMI mitigation materials.

In an exemplary embodiment, a system includes an online remixer configured to be operable for receiving a supply of the thermal management and/or EMI mitigation material including one or more functional fillers within the matrix, and remixing the one or more functional fillers including filler settlement, if any, within the matrix prior to dispensement of the thermal management and/or EMI mitigation. The remixing may reduce the filler settlement, if any, within the matrix and thereby allow for improved viscosity and flow rate of the thermal management and/or EMI mitigation material.

The online remixer may comprise a screw extruder or a screw kneader. The online remixer may be configured to be operable for homogeneously remixing the one or more functional fillers including any filler settlement within the matrix such that the viscosity and the flow rate of the thermal management and/or EMI mitigation material after the remixing is improved and/or returned to be substantially the same as an original viscosity and an original flow rate of the thermal management and/or EMI mitigation material before any filler settlement. The system may include a dispenser downstream of the online remixer. The dispenser may be configured to be operable for dispensing the thermal management and/or EMI mitigation material after the remixing, via the online remixer, of the one or more functional fillers including filler settlement, if any, within the matrix. The system may include a pump in fluid connection with the online remixer and the dispenser. The thermal management and/or EMI mitigation material may include at least about 90 weight percent of the one or more functional fillers within the matrix. The thermal management and/or EMI mitigation material may comprise a one-part or two-part dispensable thermal management and/or EMI mitigation material. The one or more functional fillers may comprise one or more of thermally-conductive particles; electrically-conductive particles; dielectric absorbing particles; electromagnetic wave absorbing particles; and particles that are two or more of thermally-conductive, electrically-conductive, dielectric absorbing, and electromagnetic wave absorbing. The thermal management and/or EMI mitigation material may comprise a one-part dispensable thermal putty or a two-part cure in place dispensable thermal interface material.

In an exemplary embodiment, a method includes receiving a supply of the thermal management and/or EMI mitigation material including the one or more functional fillers within the matrix; and remixing the one or more functional fillers including filler settlement, if any, within the matrix prior to dispensement of the thermal management and/or EMI mitigation. The remixing may reduce (e.g., eliminate, etc.) the filler settlement, if any, within the matrix and thereby allow for improved viscosity and flow rate of the thermal management and/or EMI mitigation material.

The method may include waiting an amount of time sufficient to allow at least a portion of the one or more functional fillers to settle within the matrix. The method may include remixing the at least a portion of the one or more functional fillers that settled within the matrix to thereby reduce filler settlement within the matrix and improve the viscosity and flow rate of the thermal management and/or EMI mitigation material. The method may include using a screw extruder or a screw kneader for remixing the one or more functional fillers including filler settlement, if any, within the matrix.

The method may include homogeneously remixing the one or more functional fillers including any filler settlement within the matrix such that the viscosity and the flow rate of the thermal management and/or EMI mitigation material after the remixing is improved and/or returned to be substantially the same as an original viscosity and an original flow rate of the thermal management and/or EMI mitigation material before any filler settlement.

The method may include dispensing the thermal management and/or EMI mitigation material after the remixing of the one or more functional fillers including filler settlement, if any, within the matrix.

The method may include allowing at least a portion of the one or more functional fillers to settle within the matrix; remixing the at least a portion of the one or more functional fillers that settled within the matrix to thereby reduce filler settlement within the matrix and improve viscosity and flow rate of the thermal management and/or EMI mitigation material to be substantially the same as an original viscosity and an original flow rate of the thermal management and/or EMI mitigation material before the filler settlement; and after the remixing, dispensing the thermal management and/or EMI mitigation material having the improved viscosity and the improved flow rate that are substantially the same as the original viscosity and the original flow rate of the thermal management and/or EMI mitigation material before the filler settlement.

The method may include originally mixing the one more functional fillers within the matrix to thereby provide the thermal management and/or EMI mitigation material; and after the original mixing, allowing at least a portion of the one or more functional fillers to settle within the matrix whereby the filler settlement changes an original viscosity and an original flow rate of the thermal management and/or EMI mitigation material. The method may include remixing the at least a portion of the one or more functional fillers that settled within the matrix to thereby reduce the filler settlement within the matrix and improve viscosity and flow rate of the thermal management and/or EMI mitigation material to be substantially the same as the original viscosity and the original flow rate of the thermal management and/or EMI mitigation material.

The method may include waiting at least a predetermined time period during which at least a portion of the one or more functional fillers settles within the matrix. After waiting the predetermined time period, the method may include then remixing the at least a portion of the one or more functional fillers that settled within the matrix before dispensing the thermal management and/or EMI mitigation material having the improved viscosity and the improved flow rate that are substantially the same as the original viscosity and the original flow rate of the thermal management and/or EMI mitigation material.

In this exemplary method, the thermal management and/or EMI mitigation material may include at least about 90 weight percent of the one or more functional fillers within the matrix. The thermal management and/or EMI mitigation material may comprise a one-part or two-part dispensable thermal management and/or EMI mitigation material. The one or more functional fillers may comprise one or more of thermally-conductive particles; electrically-conductive particles; dielectric absorbing particles; electromagnetic wave absorbing particles; and particles that are two or more of thermally-conductive, electrically-conductive, dielectric absorbing, and electromagnetic wave absorbing. The thermal management and/or EMI mitigation material may comprise a one-part dispensable thermal putty or a two-part cure in place dispensable thermal interface material.

The method may include after the remixing, dispensing the thermal management and/or EMI mitigation material relative to, against, and/or adjacent one or more heat sources and one or more heat removal/dissipation structures such that the dispensed thermal management and/or EMI mitigation material is operable for defining or establishing at least part of a thermally-conductive heat path generally between the one or more heat sources and the one or more heat removal/dissipation structures along which heat is transferrable.

The method may include after the remixing, dispensing the thermal management and/or EMI mitigation material relative to, against, and/or adjacent one or more device components such that the dispensed thermal management and/or EMI mitigation material is operable for providing EMI mitigation for the one or more device components.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes such feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for dispensing a thermal management and/or EMI mitigation material including one or more functional fillers within a matrix, the system comprising an online remixer configured to be operable for:
receiving a supply of the thermal management and/or EMI mitigation material including the one or more functional fillers within the matrix; and
remixing the one or more functional fillers including filler settlement, if any, within the matrix prior to dispensement of the thermal management and/or EMI mitigation, whereby the remixing reduces the filler settlement, if any, within the matrix and thereby allows for improved viscosity and flow rate of the thermal management and/or EMI mitigation material.

2. The system of claim 1, wherein the online remixer comprises a screw extruder or a screw kneader.

3. The system of claim 1, wherein the online remixer is configured to be operable for homogeneously remixing the one or more functional fillers including any filler settlement within the matrix such that the viscosity and the flow rate of the thermal management and/or EMI mitigation material after the remixing is improved and/or returned to be substantially the same as an original viscosity and an original flow rate of the thermal management and/or EMI mitigation material before any filler settlement.

4. The system of claim 1, wherein the system includes a dispenser downstream of the online remixer, the dispenser configured to be operable for dispensing the thermal management and/or EMI mitigation material after the remixing, via the online remixer, of the one or more functional fillers including filler settlement, if any, within the matrix.

5. The system of claim 4, wherein the system includes a pump in fluid connection with the online remixer and the dispenser.

6. The system of claim 1, wherein:
the online remixer comprises a screw extruder or a screw kneader configured to be operable for remixing the one or more functional fillers including any filler settlement within the matrix such that the viscosity and the flow rate of the thermal management and/or EMI mitigation material after the remixing is improved and/or returned to be substantially the same as an original viscosity and an original flow rate of the thermal management and/or EMI mitigation material before any filler settlement; and
the system includes a dispenser downstream of the online remixer, whereby the dispenser is configured to be operable for dispensing the thermal management and/or EMI mitigation material after the remixing, via the online remixer, of the one or more functional fillers including filler settlement, if any, within the matrix.

7. The system of claim 1, wherein the thermal management and/or EMI mitigation material includes at least about 90 weight percent of the one or more functional fillers within the matrix.

8. The system of claim 1, wherein the thermal management and/or EMI mitigation material comprises a one-part or two-part dispensable thermal management and/or EMI mitigation material; and/or wherein the one or more functional fillers comprise one or more of:
thermally-conductive particles;
electrically-conductive particles;
dielectric absorbing particles;
electromagnetic wave absorbing particles; and
particles that are two or more of thermally-conductive, electrically-conductive, dielectric absorbing, and electromagnetic wave absorbing.

9. The system of claim 1, wherein the thermal management and/or EMI mitigation material comprises:
a one-part dispensable thermal putty; or
a two-part cure in place dispensable thermal interface material.

10. A method of dispensing a thermal management and/or EMI mitigation material including one or more functional fillers within a matrix, the method comprising:
receiving a supply of the thermal management and/or EMI mitigation material including the one or more functional fillers within the matrix; and
remixing the one or more functional fillers including filler settlement, if any, within the matrix prior to dispensement of the thermal management and/or EMI mitigation, whereby the remixing reduces the filler settlement, if any, within the matrix and thereby allows for improved viscosity and flow rate of the thermal management and/or EMI mitigation material.

11. The method of claim 10, wherein:
the method includes waiting an amount of time sufficient to allow at least a portion of the one or more functional fillers to settle within the matrix; and
remixing includes remixing the at least a portion of the one or more functional fillers that settled within the matrix to thereby reduce filler settlement within the matrix and improve the viscosity and flow rate of the thermal management and/or EMI mitigation material.

12. The method of claim 10, wherein remixing includes using a screw extruder or a screw kneader for remixing the one or more functional fillers including filler settlement, if any, within the matrix.

13. The method of claim 10, wherein remixing includes homogeneously remixing the one or more functional fillers including any filler settlement within the matrix such that the viscosity and the flow rate of the thermal management and/or EMI mitigation material after the remixing is improved and/or returned to be substantially the same as an original viscosity and an original flow rate of the thermal management and/or EMI mitigation material before any filler settlement.

14. The method of claim 10, wherein the method includes dispensing the thermal management and/or EMI mitigation material after the remixing of the one or more functional fillers including filler settlement, if any, within the matrix.

15. The method of claim 10, wherein the method includes:
allowing at least a portion of the one or more functional fillers to settle within the matrix;
remixing the at least a portion of the one or more functional fillers that settled within the matrix to thereby reduce filler settlement within the matrix and improve viscosity and flow rate of the thermal management and/or EMI mitigation material to be substantially the same as an original viscosity and an original flow rate of the thermal management and/or EMI mitigation material before the filler settlement; and
after the remixing, dispensing the thermal management and/or EMI mitigation material having the improved viscosity and the improved flow rate that are substantially the same as the original viscosity and the original flow rate of the thermal management and/or EMI mitigation material before the filler settlement.

16. The method of claim 10, wherein the method includes:
originally mixing the one more functional fillers within the matrix to thereby provide the thermal management and/or EMI mitigation material; and
after the original mixing, allowing at least a portion of the one or more functional fillers to settle within the matrix whereby the filler settlement changes an original viscosity and an original flow rate of the thermal management and/or EMI mitigation material; and
wherein the remixing includes remixing the at least a portion of the one or more functional fillers that settled within the matrix to thereby reduce the filler settlement within the matrix and improve viscosity and flow rate of the thermal management and/or EMI mitigation material to be substantially the same as the original viscosity and the original flow rate of the thermal management and/or EMI mitigation material.

17. The method of claim 15, wherein:
allowing at least a portion of the one or more functional fillers to settle within the matrix includes waiting at least a predetermined time period during which the at least a portion of the one or more fillers settles within the matrix; and
after waiting the predetermined time period, then remixing the at least a portion of the one or more functional fillers that settled within the matrix before dispensing the thermal management and/or EMI mitigation material having the improved viscosity and the improved flow rate that are substantially the same as the original viscosity and the original flow rate of the thermal management and/or EMI mitigation material.

18. The method of claim 10, wherein the thermal management and/or EMI mitigation material includes at least about 90 weight percent of the one or more functional fillers within the matrix.

19. The method of claim 10, wherein the thermal management and/or EMI mitigation material comprises a one-part or two-part dispensable thermal management and/or EMI mitigation material; and/or wherein the one or more functional fillers comprise one or more of:
thermally-conductive particles;
electrically-conductive particles;
dielectric absorbing particles;
electromagnetic wave absorbing particles; and
particles that are two or more of thermally-conductive, electrically-conductive, dielectric absorbing, and electromagnetic wave absorbing.

20. The method of claim 10, wherein the thermal management and/or EMI mitigation material comprises:
a one-part dispensable thermal putty; or
a two-part cure in place dispensable thermal interface material.

21. The method of claim 10, wherein the method includes after the remixing, dispensing the thermal management and/or EMI mitigation material:
relative to, against, and/or adjacent one or more heat sources and one or more heat removal/dissipation structures such that the dispensed thermal management and/or EMI mitigation material is operable for defining or establishing at least part of a thermally-conductive heat path generally between the one or more heat sources and the one or more heat removal/dissipation structures along which heat is transferrable; and/or
relative to, against, and/or adjacent one or more device components such that the dispensed thermal management and/or EMI mitigation material is operable for providing EMI mitigation for the one or more device components.
